(19) United States
(12) Patent Application Publication
(10) Pub. No.: US 2011/0020046 A1
(43) Pub. Date: Jan. 27, 2011

(54) COSMETICS UNIT COMPRISING TWO PARTIAL UNIT CONNECTABLE BY MEANS OF A COUPLING SLEEVE

(75) Inventors: Norbert Dumler, Ansbach (DE); Werner Fischer, Burk (DE)

Correspondence Address: Browdy and Neimark, PLLC, 1625 K Street, N.W., Suite 1100, Washington, DC, 20006, US

(73) Assignee: GEKA BRUSH GMBH, Bechhofen (DE)

(21) Appl. No.: 12/673,899

(22) PCT Filed: Aug. 18, 2008
(86) PCT No.: PCT/EP08/06761

§ 371 Date: Feb. 17, 2010

(30) Foreign Application Priority Data
Aug. 17, 2007 (EP) 07016143.5

(51) Int. Cl. B05C 1/00

(52) U.S. Cl. 401/17

(57) ABSTRACT

The unit for cosmetics (1) comprises two partial units (2, 3) with a reservoir (5, 6) each for the intake of a cosmetic substance and with a closure cap (7, 8) each, with which the associated reservoir (5, 6) can be closed. Both partial units (2, 3) are connected in a releasable way by means of a coupling sleeve (4). On both axial front sides thereof, one of the two closure caps (7, 8) can be inserted. The coupling sleeve (4) is made of metal. At least the closure caps (7, 8) are made of plastic. The coupling sleeve (4) comprises a safety element at an inner wall per insertable closure cap (7, 8) extruding to the inside, designed as a ring element running in the circumferential direction by means of longitudinal elements that are parallel to the central longitudinal axis. A releasable connection of the coupling sleeve (4) to the associated closure cap (7, 8) comprises a torsional strength due to the longitudinal elements and an axial strength due to the ring element.

The invention relates to a cosmetics unit with a central longitudinal axis and comprising two partial units with a storage container each for receiving a cosmetic substance, and with a closure cap each, by means of which the respective storage container can be closed, wherein the two partial units can be detachably connected with each other by means of a coupling sleeve, at whose two axial end faces one of the two closure caps, respectively, can be inserted.

Such a cosmetics unit, which is completely manufactured from plastic, is known, for example, from EP 1 348 352 B1. The same or different cosmetics, such as nail polish, mascara, eye-shadow, lip-gloss or substances for removing the same can be filled into the two storage containers, which can be closed by screwing. In the known cosmetics unit, both closure caps and the coupling sleeve are detachably connected with each other by means of an axially extending toothing and by means of a latching groove-latching bead-connection provided separately from the axial toothing. Because of the separate connecting mechanisms, a varying wall thickness also provided, and a separating transversal wall in the interior, the embodiment of the coupling sleeve known from EP 1 348 352 B1 requires certain minimum dimensions in order to be able to manufacture it as a plastic part with an expenditure that is still reasonable. Of course, this also imposes limits on the possible options with regard to the design of the cosmetics unit as a whole. Moreover, a certain minimum wall thickness of the plastic part is necessary in order to achieve sufficient mechanical rigidity and in order to avoid sink marks. Nevertheless, there is a need for further improvement of the mechanical properties of this cosmetics unit, and primarily of those of the coupling sleeve, which is under particular strain.

A slightly differently designed double cosmetics unit is described in US 2004/0234321 A1, in which the closure caps of the two partial units are inserted into a coupling sleeve so as not to be detachable again. Handling is thus limited. In particular, it is not possible to change the combination of the cosmetics unit later, for example by joining two other partial units by means of the coupling sleeve.

The same applies to the further double cosmetics unit described in WO 2006/090971 A1, in which the two closure caps are also firmly inserted into the coupling sleeve and cannot be removed again therefrom.

In US 2003/0106201 A1, a storage container of a cosmetics unit is described which consists of an aluminum alloy, and whose outer wall is anodized.

DE 825 874 C describes a double cosmetics unit in which the two lipsticks/eyebrow pencils, which can be connected with each other by means of a simple hollow-cylindrical coupling sleeve, each have a radially peripheral projection. This projection forms a stop when the sticks/pencils are inserted into the coupling sleeve.

It is thus the object of the invention to provide a cosmetics unit of the type mentioned above, which, while providing simple and flexible handling, has very good mechanical properties at the same time. A cosmetics unit in accordance with the features of patent claim 1 is specified in order to achieve this object. In the cosmetics unit according to the invention, the coupling sleeve consists of a metal, with at least the closure caps consisting of a plastic, and the coupling sleeve comprises at an inner wall, for each insertable closure cap, at least one inwardly protruding combined securing element, which is configured as an annular element which extends peripherally in the circumferential direction and is structured by means of longitudinal elements oriented parallel to the central longitudinal axis, so that a detachable connection of the coupling sleeve with the respective closure cap has a rotation-preventing strength due to the longitudinal elements, and an axial strength due to the annular element.

In the cosmetics unit according to the invention, very different materials are provided for individual components. Whereas the closure caps, as well as, in particular, the other parts of the two partial units are manufactured from plastic, a metal material is used for the coupling sleeve. Because of the very different materials, this can only be fabricated with an additional expenditure and is thus, at first glance, uneconomical. It was found, however, that a coupling sleeve manufactured from metal leads to a mechanical behavior that is considerably improved as compared with a solution consisting completely of plastic. The metal coupling sleeve has a higher surface quality, and also a higher bending stiffness and breaking strength because of the considerably higher modulus of elasticity as compared to plastic. The operational life of the coupling sleeve is thus considerably increased, because plastic components often become brittle after a certain time, thus breaking more easily.

Moreover, the metal coupling sleeve opens up new possibilities for aesthetic design. The metal used gives the cosmetics unit a high-quality appearance. A comparable metallic gloss cannot be achieved by mere coloring of a plastic part. A coupling sleeve from metal is particularly robust. Its surface is significantly more scratch and abrasion resistant than an execution in plastic. A longer period of use can thus be achieved. This is of interest particularly in the case of the coupling sleeve, since that is the component of the cosmetics unit which is potentially in use for the longest period of time because of its multiple use.

Moreover, it is possible, for example, to provide a very small wall thickness in the coupling sleeve of the cosmetics unit according to the invention. Compared with a execution in plastic, a significantly thinner wall thickness can be used without any loss of functional capability of the coupling sleeve, that is, both in mechanical stability and rigidity of the coupling sleeve itself, as well as in the strength of the connection realized between the coupling sleeve and the respective closure cap. This results in more design options with regard to the other components of the cosmetics unit. In particular, a cosmetics unit with a very slender outer shape, that is, with a comparably small external diameter, can be realized.

Because of the very good mechanical properties, primarily of the metal coupling sleeve, it is furthermore sufficient to provide only a single combined securing element per closure cap on the coupling sleeve. Nevertheless, a connection with the respective closure cap, which is detachable but still has very good rotation-preventing strength as well as very good axial strength, can be established in this manner. Each of the combined securing elements attached to the inner wall, which is in particular substantially hollow-cylindrical, or encloses an interior with circular cross-sectional areas that are at least oriented in some areas perpendicular to the central longitudinal axis, has a multiple action. Due to the annular element, it ensures, on the one hand, a securing action in the axial direction, that is, in the direction of the central longitudinal axis. On the other hand, the structuring of the annular elements by means of the longitudinal elements, which may be, in particular, axially extending longitudinal grooves or longitudinal webs, and which are preferably disposed uniformly distributed in the circumferential direction, offers a rotation-preventing action, that is, a securing action in the circumferential direction. The closure caps, at their outer wall facing, in the assembled state, the inner wall of the coupling sleeve, are preferably provided with a coupling element, that is, for example, a latching groove extending in an annular manner in the circumferential direction and also structured by longitudinal elements, which corresponds and cooperates with the combined securing element.

The coupling with the closure caps and primarily also the rotation-preventing action can be obtained also without using rigid connecting means, such as adhesives, press connections or the like, if the metal coupling sleeve according to the invention is used. The detachable connection of the metal coupling sleeve with the closure caps thus provided enables a very advantageous individual filling of the storage containers of the two partial units and also, furthermore, flexible handling. The partial units of a cosmetics unit according to the invention can be individually combined without any problems and also changed later on.

Advantageous embodiments of the cosmetics unit according to the invention result from the features of the claims dependent on claim 1.

A variant in which an, in particular, uniform wall thickness of the coupling sleeve lies in the range of between 0.05 mm and 1 mm, preferably between 0.05 mm and 0.55 mm, is advantageous. Preferably, this wall thickness is a basic wall thickness, which is thus specified, in particular, independent from structures possibly provided on the wall. Coupling sleeves with walls so thin can preferably only be manufactured from metal with reasonable effort. They open up a particularly large number of design options with regard to the other components of the cosmetics unit. Moreover, such a small wall thickness causes a low consumption of materials and also a very low weight of the coupling sleeve. Stability is ensured nevertheless.

In another advantageous embodiment, the coupling sleeve consists of aluminum. This is a very light but nevertheless rugged metal. The result is a coupling sleeve with a low weight.

Preferably, the coupling sleeve can furthermore be provided with a surface coating. The surface properties, such as, for example, scratch resistance, and also the visual appearance of the surface can thus be improved. For example, a clear varnish or optionally a colored varnish can be provided as a surface coating. A different surface treatment is also possible. For example, the surface can be, in particular, anodized.

According to another advantageous variant, a web which extends peripherally tangentially, i.e. in the circumferential direction, and which protrudes radially outwardly, is provided on the closure cap as an axial end stop for the coupling sleeve. The coupling sleeve is thus prevented from being pushed too far onto the closure cap.

Furthermore, it is advantageous if the closure cap is provided on an outer circumferential surface with longitudinal webs which are disposed uniformly distributed in the circumferential direction, protrude radially outwardly and in particular form a furrowed portion, with, in particular, between four and 48, preferably between four and 16, longitudinal webs being provided. These longitudinal webs cooperate with structural elements preferably provided on the inner wall of the metal coupling sleeve, in particular with corresponding longitudinal grooves or with groove-like interstices or depressions formed between longitudinal webs, so that a detachable connection secured against rotation is provided.

Furthermore, it can advantageously be provided that the closure caps of the two partial units are configured in a constructionally identical manner. The closure caps thus have the same geometry on both sides. This results in a small number of components that saves costs.

It is also preferably possible that the coupling sleeve has an outer diameter in the range of between 10 mm and 20 mm, in particular in the range of between 12 mm and 15 mm. An aesthetically attractive slender design can thus be selected also for the cosmetics unit as a whole.

In particular, the coupling sleeve is furthermore provided on its outer circumferential surface with two annular depressions, which also become apparent on the inner wall of the coupling sleeve as inwardly directed annular projections and form the annular elements there. The depressions are, for example, embossed from the outside. This can be carried out, for example, by means of a rolling movement over an appropriately formed tool. The depressions have a two-fold function. Seen from the outside, they are visually attractive 3D design elements. On the inner wall, the projections (=annular elements) form latching beads or snap-in rings for axially fixing the connections between the coupling sleeve and the closure caps. In order for the depressions embossed from the outside to cause the desired advantageous latching beads also on the inner wall, thus resulting in a simple production method for the inside latching beads, a thin wall thickness in the above-mentioned preferred range, in particular, should be used for the coupling sleeve.

Preferably, the inwardly directed annular projections (=annular elements) have a radial dimension in the range of between 0.03 mm and 0.8 mm, in particular between 0.15 mm and 0.2 mm. The inwardly directed annular projections form latching beads or snap-in rings whose snap-in ring projection length over the rest of the inner wall of the coupling sleeve is just equal to the aforementioned radial dimension.

Furthermore, a ratio between a wall thickness of the coupling sleeve and a projection length of the inwardly directed annular projections over the rest of an inner wall is preferably in the range of 1.25 and 33, in particular between 2.5 and 5.5.

According to another advantageous embodiment, the coupling sleeve is provided on an inner wall with axially extending and inwardly protruding rotation-preventing projections. Thus, a rotation-preventing action in the plugged-together state is achieved in a simple way.

Preferably, the rotation-preventing projections extend axially across the annular elements of the combined securing elements and form, in the area of the annular elements, their longitudinal elements provided for structuring, in this case, thus, inwardly protruding longitudinal webs. This simplifies handling considerably. The continuous rotation-preventing projections, i.e. the rotation-preventing projections which substantially extend over the entire length of the coupling sleeve, can be manufactured by means of a deep-drawing technique. The rotation-preventing action is in that case obtained both in the area of the structured annular elements, as well as outside of them.

Preferably, the rotation-preventing projections run out at a distance from an axial edge of the coupling sleeve. In particular, they run out in a pointed manner. This facilitates inserting the closure cap into the coupling sleeve from this edge. In this embodiment, the pressing action and, thus, the strength of the rotation-preventing action increase as the closure cap is inserted further into the coupling sleeve. The greatest pressing action is present in the completely inserted state. In principle, the axial rotation-preventing projections can also run out in a pointed manner just at the very axial edge of the coupling sleeve. The successive increase of the action of the pressing force with an increasing insertion depth is thus also obtained. In the known plastic sleeves according to EP 1 348 352 B1, it is not provided that the rotation-preventing projections run out spaced apart from the axial direction and/or in a pointed manner, because these plastic parts have a certain demolding bevel anyway.

In another preferred variant, the rotation-preventing projections extend just up to an axial edge of the coupling sleeve. This variant can be realized particularly easily, for example, by means of a cold-extrusion technique, by means of a deep-drawing technique, or by implementing it as a drawn tube.

It is furthermore advantageous if the coupling sleeve is provided with four to 48 of the rotation-preventing projections. On the one hand, a number of rotation-preventing projections lying within this interval can be fabricated well, and on the other hand offers a good protection against rotation in the assembled state of the cosmetics unit.

According to another advantageous variant, the rotation-preventing projections have a tangential dimension, i.e. a projection width, in the range of between 0.3 mm and 15.0 mm, in particular between 0.6 mm and 2.0 mm. This variant also offers the aforementioned advantages with regard to fabrication and protection against rotation.

Moreover, it can advantageously be provided that the rotation-preventing projections, perpendicular to the axial direction, have a curvature with a curvature radius in the range of between 0.15 mm and 20.0 mm, in particular between 0.8 mm and 3.4 mm. This curvature facilitates the assembly and the separation of the coupling sleeve and the closure cap.

In particular, the rotation-preventing projections furthermore have a radial dimension, i.e. a projection height, in the range of between 0.05 mm and 0.25 mm, and they stay invisible, in particular at an outer wall of the coupling sleeve. The range of values specified for the projection height is advantageous with regard to good protection against rotation.

Advantageously, the rotation-preventing projections do not become apparent on the outer wall of the coupling sleeve that is visible from the outside. The attractive visual overall impression of the coupling sleeve is thus not affected by the rotation-preventing projections provided on the inner walls.

According to another embodiment, the coupling sleeve has an inner space which, apart from the combined securing elements, tapers from an axial edge towards the other axial edge, with the inside diameter of the inner space on the two axial edges differing from each other by a diameter difference of 0.2 mm to 0.5 mm, in particular of 0.25 mm. In particular, a coupling sleeve with rotation-preventing projections axially extending on the inner wall can be produced particularly well if it possesses such a slightly conical inside shape. In that case, a cold-extrusion technique can be used, such as the deep-drawing technique. An easy mold release is provided due to the conicity.

According to another embodiment, the coupling sleeve has a structured outer surface accompanied by a non-uniform wall thickness. Thus, novel, very attractive and high-quality outward forms of appearance can be realized for the coupling sleeve. The wall thickness differences provided in this case can be, in particular, in a range of at least 0.5 mm. This can be realized without any problems with the metal material provided for the coupling sleeve. In contrast, such large differences in wall thickness would lead to considerable difficulties with regard to the realization in the case of pure plastic solutions.

According to another embodiment, the coupling sleeve is provided on an outer wall with a decoration or inscription applied, in particular scratched or engraved, into an outer surface, so that in particular the otherwise smooth and/or continuous structure of the outer surface is disrupted. Such an engraved decoration/inscription is possible in particular due to the metal material used. It can also be produced later, e.g. after the basic body of the coupling sleeve has been produced. A comparable marking cannot be realized in pure plastic units. The engraving provides a permanent and very high-quality decoration/inscription. In contrast to printed decorations/inscriptions, engraved elements retain their appearance even after a longer period of use. They cannot be wiped or scraped off, neither intentionally nor unintentionally.

According to another embodiment, the inner wall of the coupling sleeve, apart from the combined securing elements, has an uncontoured inner wall surface with a preferably smooth and/or continuous structure. The combined securing elements are therefore in particular the only structural elements present on the inner wall. Preferably, such a coupling sleeve is a lathed component that can be manufactured well in a lathe.

Other objects, advantages and details of the invention become apparent from the following description of exemplary embodiments with reference to the drawing. In the drawings:

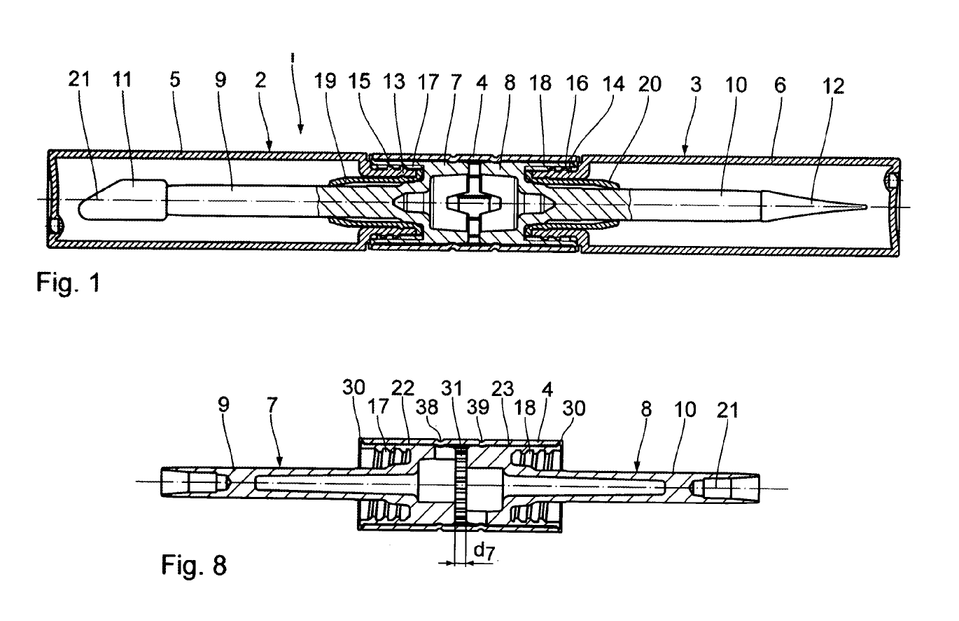

FIG. 1 shows an exemplary embodiment of a double cosmetics unit with two partial units connected with each other by means of a coupling sleeve,

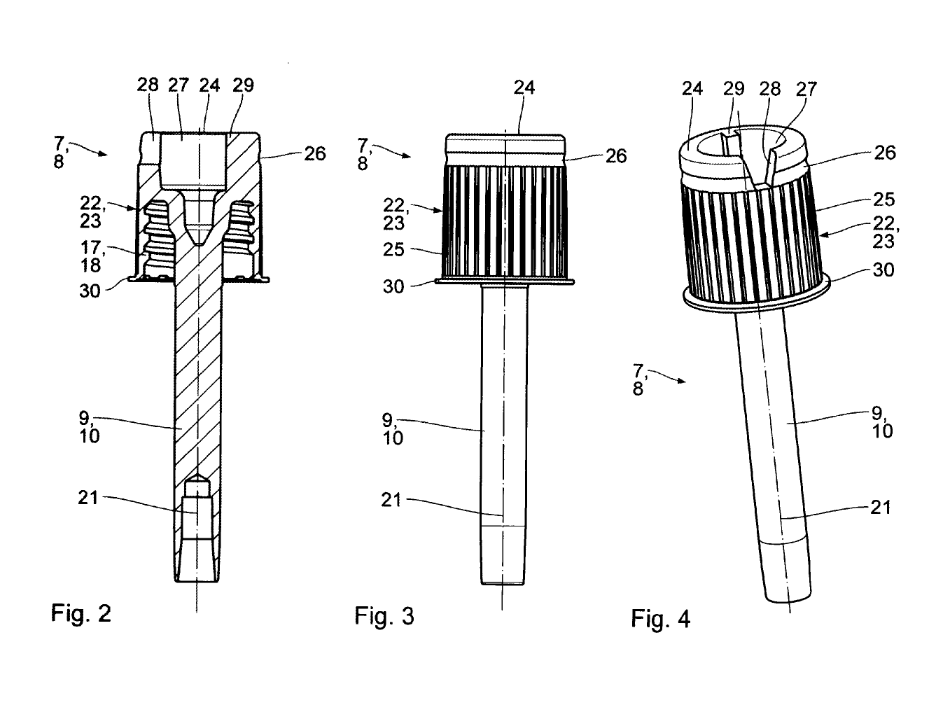

FIGS. 2 to 4 show an exemplary embodiment of a closure cap for one of the partial units according to FIG. 1 in a longitudinal section view, in a lateral view and a perspective view, respectively,

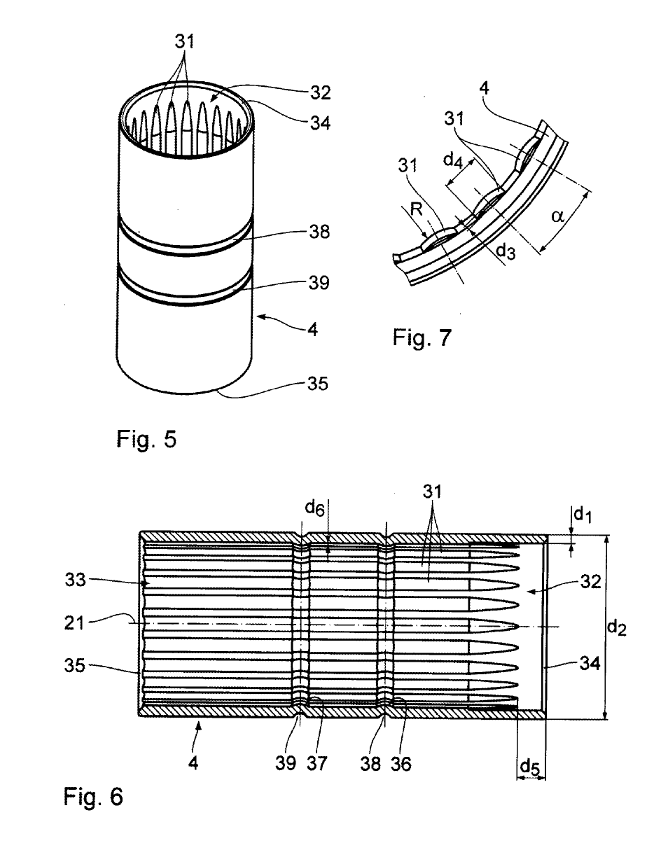

FIGS. 5 to 7 show an exemplary embodiment of a coupling sleeve of the double cosmetics unit according to FIG. 1 in a perspective view, in a longitudinal section view and in a sectional view, respectively,

FIG. 8 shows two closure caps according to FIGS. 2 to 4 and the coupling sleeve according to FIGS. 5 to 7 in the plugged-together state and in a longitudinal section view,

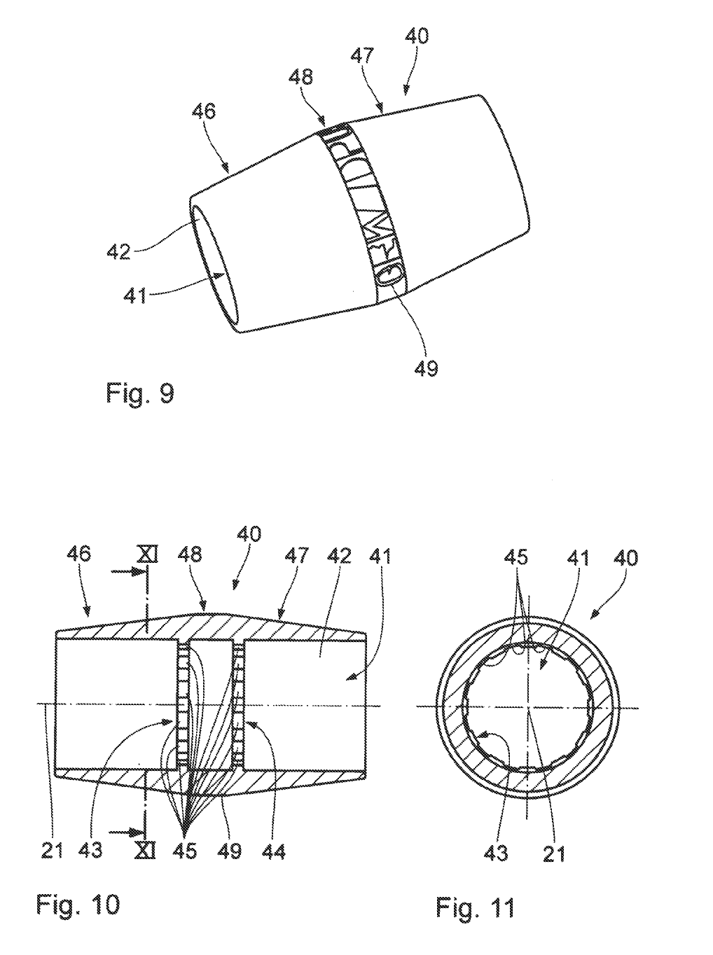

FIGS. 9 to 11 show an exemplary embodiment of a coupling sleeve of another double cosmetics unit in a perspective view as well as in a longitudinal and cross-sectional view, respectively

Parts corresponding to one another are provided with the same reference numerals in the FIGS. 1 to 11.

FIG. 1 shows an exemplary embodiment of a cosmetics unit 1 with two partial units 2 and 3. The partial units 2 and 3 are connected with each other by means of a coupling sleeve 4 made of metal. This connection is configured so as to be detachable.

The partial units 2 and 3 made of plastic each contain a storage container 5 and 6, respectively, which can be tightly sealed by means of a closure cap 7 and 8, respectively, which can be screwed on, for example. A cosmetic substance into which a stem 9 and 10, respectively, which is molded onto the respective closure cap 7 or 8, dips, is located in the storage containers 5 and 6. The cosmetics filled into the storage containers 5 and 6 can be different from each other. In the exemplary embodiment, the partial unit 2 is filled with a lip-gloss liquid and the partial unit 3 is filled with an eyeliner liquid. An applicator 11 and 12, respectively, is attached to the immersed stem. In the exemplary embodiment, the applicator 11 is a lip-gloss brush or sponge and the applicator 12 is an eyeliner brush. In principle, the storage containers 5 and 6, respectively, can, however, also be filled with other cosmetics, such as nail polish, mascara or eye-shadow. Accordingly, the applicators 11 and 12 are configured differently in those cases, namely adapted to their respective functions.

Each of the two storage containers 5 and 6 comprises at its container opening a tapered neck 13 and 14, respectively, with an external thread 15 and 16, respectively, onto which the closure cap 7 and 8, respectively, provided with a corresponding internal thread 17 and 18, respectively, can be screwed. The stem 9 and 10, respectively, is integrally connected with the respective closure cap 7 and 8, respectively.

A wiper means 19 and 20, respectively, is placed on or inserted into each of the necks 13 and 14, with an annular collar of the wiper means 19 and 20, respectively, simultaneously serving as a gasket in the area of the respective container opening.

The constructionally identical closure caps 7 and 8, which are shown in FIGS. 2 to 4 individually and without the applicator 11 and 12, respectively, placed on them, at the same time serve as coupling parts for assembling the cosmetics unit 1. The partial units 2 and 3 are inserted into the coupling sleeve 4 in the direction of a central longitudinal axis 21 of the cosmetics unit 1 from both axial end faces. The area of the closure cap 7 and 8, respectively, in which the respective internal thread 17 and 18, respectively, is located, is also configured as a coupling portion 22 and 23, respectively, for this purpose. Its outer contour slightly tapers in the direction of its axial end face 24 facing away the respective storage container 5 and 6, respectively. Thus, the coupling portion 22 and 23, respectively, has a slightly conically tapering outer shape. This facilitates inserting the closure cap into the coupling sleeve 4.

Moreover, the outer circumferential surface of the coupling portion 22 and 23, respectively, is provided with a furrowed portion 25, whose tangentially uniformly distributed elevations (=longitudinal webs) and (groove-like) depressions extend parallel to one another in the axial direction, i.e. in the direction of the central longitudinal axis 21. The furrowed portion 25 does not reach up to the axial end face 24. It ends at a tangentially extending peripheral latching groove 26. The longitudinal webs of the elevations run out towards the latching groove 26, that is, their height decreases towards the latching groove 26, so that they at least contribute to or form the already mentioned slightly conically tapering outer circumferential surface of the coupling portion 22 and 23, respectively. The furrowed portion 25 comprises in particular up to 48 such longitudinal webs. The latching groove 26 has a rounded, in particular a circular arc-shaped cross sectional form. In an alternative embodiment not shown, the furrowed portion 25 with its longitudinal webs also extends into the latching groove 26. The closure cap 7 and 8, respectively, is at least partially hollow. On the axial end face 24, it has a cap cavity 27 extending in the axial direction. The wall formed due to this cap cavity 27 in the area of the coupling portion 22 and 23, respectively, is interrupted by an edge recess 28, which, starting from the edge at the axial end face 24, extends in the direction of the stem 9 and 10, respectively. In the exemplary embodiment according to FIG. 2, the edge recess 28 extends up into the area of the latching groove 26. Apart from this interruption by the edge recess 28, the latching groove 26 is formed to be continuous, that is, as a single structural element. The cap cavity 27 and the edge recess 28 increase elasticity in the area of the coupling portion 22 and 23, respectively, which facilitates joining and separating the partial units 2 and 3 and the coupling sleeve 4.

Moreover, a web 29, which, also starting from the edge of the axial end face 24 extends in the direction of the stem 9 and 10, respectively, is provided at the inner wall of the cap cavity 27. In the exemplary embodiment shown in FIG. 2, the edge recess 28 and the web 29 lie opposite each other.

On the axial side of the furrowed portion 25 facing away from the latching groove 26, a tangentially peripheral web, which radially protrudes over an imaginary outer boundary surface of the coupling portion 22 and 23, respectively, in the area of the furrowed portion 25, is provided. This web forms an axial end stop 30 which prevents the associated closure cap 7 and 8, respectively, from being pushed too far into the coupling sleeve 4. Thus, the end stop 30 forms a second axial end of the coupling portion 22 and 23, respectively. The first axial end is the axial end face 24, which at the same time is also the one axial end of the closure cap 7 and 8, respectively.

The exemplary embodiment of the coupling sleeve 4 shown in more detail in FIGS. 5 to 7 is provided for the detachable connection of the two closure caps 7 and 8, or the partial units 2 and 3, respectively.

The coupling sleeve 4 is hollow throughout. It has the basic shape of a hollow cylinder and in the exemplary embodiment shown is made from an aluminum tube with an, in particular uniform, basic tube wall thickness d₁ of 0.625 mm and an external diameter d₂ of about 13.15 mm. Due to this very thin wall thickness of the coupling sleeve 4, the cosmetics unit 1 on the whole can be realized with a very slender shape. Despite the small wall thickness d₁, the aluminum tube used ensures a sufficient mechanical strength of the coupling sleeve 4, and primarily also of the assembled cosmetics unit 1. The use of a metal as a starting material for the coupling sleeve 4 also leads to very favorable surface properties with a high scratch and abrasion resistance, and to an extraordinary visual appearance of the cosmetics unit. The result is totally new design options.

The outside of the coupling sleeve 4 is provided with a surface coating, such as a varnish coating. Alternatively, an anodized surface is also conceivable. On the whole, the coupling sleeve 4 has a very scratch and abrasion resistance surface, both because of the metal material used, as well as because of this surface coating. It is thus ensured that the appearance of the coupling sleeve 4 is not diminished even after prolonged and, above all, multiple use. The coupling sleeve 4 is the component of the cosmetics unit 1, which potentially has the longest period of use. It is thus advantageous to configure this component with particular long-term stability. In this regard, the metal used for the coupling sleeve 4 has significant advantages over the otherwise commonly used plastic material.

On the inner wall of the hollow cylinder of the coupling sleeve 4, radially inwardly protruding and axially extending rotation-preventing projections 31 are disposed. In the exemplary embodiment according to FIGS. 5 and 6, a total of 24 rotation-preventing projections 31 disposed uniformly distributed in the circumferential direction are provided which, depending on the axial position, protrude inwardly with a maximal projection height d₃ of up to 0.125 mm from the inner wall. Tangentially adjacent rotation-preventing projections 31 are therefore respectively spaced from one another by a circumferential offset angle α of 15°. They have a curvature with a curvature radius R of 1.125 mm and, in the tangential direction, have a projection width d₄ of 0.951 mm. The rotation-preventing projections 31 on the inner wall of the coupling sleeve 4 are manufactured during the deep-drawing of the aluminum tube.

At the one axial end face, the cavity of the coupling sleeve 4 forms a first coupling recess 32, and on the other axial end face, a second coupling recess 33. The two coupling recesses 32, 33 differ slightly from each other, in particular due to the manufacturing technique employed. For example, the rotation-preventing projections 31, at the coupling recess 32, run out in a pointed manner and end at a distance d₅ of a few mm, e.g. of 2 mm, before the one axial edge 34 of the coupling sleeve 4, whereas they extend, at the coupling recess 33, just up to the other axial edge 35 of the coupling sleeve 4. However, it is also possible in principle to provide coupling recesses 32 and 33 which are configured in the same way on both axial sides of the coupling sleeve 4.

When the closure cap 7 or 8 is inserted into the coupling recesses 32 and 33, respectively, of the coupling sleeve 4, the rotation-preventing projections 31 cooperate with the furrowed portion 25 on the outside of the slightly conically shaped coupling portion 22 and 23, respectively. This results in an axially extending toothing, so that a detachable, but nevertheless non-rotatable connection exists between the closure cap 7 and 8, respectively, and the coupling sleeve 4.

Moreover, on the inner wall of the hollow cylinder of the coupling sleeve 4, a latching bead 36 and 37, respectively, which runs over the complete circumference in the circumferential direction and protrudes radially inwardly, is provided in each of the two coupling portions 22 and 23. The latching bead 36 and 37, respectively, which forms a snap-in ring, protrudes inwardly in the embodiment with a snap-in ring projection length d₆ of approximately 0.175 mm from the rest of the inner wall of the coupling sleeve 4. A ration between the basic tube wall thickness d₁ to the snap-in ring projection length d₆ in the exemplary embodiment is therefore about 3.5. Each of the two latching beads 36 and 37 corresponds with a circumferential groove 38 and 39, respectively, which also extends tangentially over the complete circumference of the outside of the coupling sleeve 4. The latching beads 36 and 37 and the circumferential grooves 38 and 39, respectively, are manufactured by means of an appropriate embossing processing of the coupling sleeve 4 consisting of aluminum. They each have a circular arc-shaped cross-sectional contour. The cross section of the circumferential grooves 38 and 39 is determined by a groove curvature radius of about 0.5 mm in the exemplary embodiment. On the visible outside of the coupling sleeve 4, the depressions of the circumferential grooves 38 and 39 constitute visually attractive design elements in the form of peripheral rings.

In contrast, the corresponding latching beads 36 and 37 extending within the coupling sleeve 4 fulfil a technical function. They lead to an axial fixation in conjunction with the latching grooves 26 provided on the coupling portions 22 and 23 when the closure caps 7 and 8 are inserted. This is achieved when the latching grooves 36 and 37 are latched into the respectively associated one of the latching groove 26. The cross-sectional contours of the latching beads 36 and 37 and of the latching grooves 26 are adapted to one another. They are substantially identical.

The rotation-preventing projections 31 extending on the inner wall of the coupling sleeve 4 in the axial direction also extend across the latching beads 36 and 37. The latching beads 36 and 37 extending in the circumferential direction are annular elements structured by the rotation-preventing projections 31, which extend perpendicularly to them and constitute longitudinal webs. Thus, the latching beads 36 and 37 are combined securing elements, because of the annular shape on the one hand, and because of the axial structuring superposed over the annular shape and caused by the rotation-preventing projections 31 on the other hand. In particular in the case of an appropriately correspondingly configured outer contour of the closure caps 7 and 8, they cause a securing action in the area of the latching groove 26 both in the axial direction as well as in the circumferential direction.

A longitudinal section view of a partially assembled state is shown in FIG. 8, in which the two closure caps 7 and 8 are inserted from both axial sides into the coupling sleeve 4. Because of the end stops 30, it is ensured that the coupling portions 22 and 23 of the two closure caps 7 and 8, respectively, do not abut against each other within the coupling sleeve 4. A slight remaining distance d₇ always remains.

Because of the above-described advantageous assemblable configuration of the cosmetics unit 1 with the coupling sleeve 4, it is possible for the manufacturer to separately and independently fill and handle the storage containers 5 and 6 with conventional machines. The closure caps 7 and 8 are also screwed on like conventional screw-on caps using existing machines. The partial units 2 and 3 thus manufactured can be individually stored and transported. They can be joined at any time to form the cosmetics unit 1. This can take place at the manufacturer or the dealer—at the latter, in particular, even only upon demand by the respective customer. For this purpose, its is only necessary to plug them on from both sides onto the common coupling sleeve 4.

For practical use, the respective partial unit 2 or 3, which is not used, can be screwed off, together with the closure cap 8 and 7, respectively, which is firmly or non-rotatably connected via the coupling sleeve 4, from the storage container 6 and 5, respectively, with the cosmetic substance to be used, and in the process serve as a kind of handle which enables a particularly simple handling.

If one of the storage containers 5 and 6 is empty, the entire cosmetics unit 1 need not be thrown away. Rather, the empty partial unit 2 or 3 can be replaced with a new one. Only the plug-in connection on the coupling sleeve 4 must be detached to this end. The still functional, completely or partially filled partial unit 3 or 2 can then be combined with a new partial unit 2 or 3, with either the original combination of the cosmetics unit 1 being recreated again, or, if so demanded by the consumer, a new combination being provided.

FIGS. 9 to 11 show an exemplary embodiment of a coupling sleeve 40 of another double cosmetics unit, which is not illustrated in more detail. The coupling sleeve 40 also serves for detachably connecting two closure caps 7 and 8, and two partial units 2 and 3, respectively. The coupling sleeve 40 is a lathed component, which is again manufactured from aluminum. It has a substantially hollow-cylindrical inner space 41 with an inner wall 42 for receiving the closure caps 7 and 8.

For each closure cap 7 or 8 to be received, one inwardly protruding structured annular element 43 and 44, respectively, which circumferentially extends over the entire circumference, is respectively provided on the inner wall 42. This structuring is formed by longitudinal grooves 45 introduced into the annular elements 43 and 44. The latter extend axially and are disposed uniformly distributed in the circumferential direction in the ring elements 43 and 44. In the exemplary embodiment shown, twelve such longitudinal grooves 45 are provided per annular element 43 and 44, respectively, with a different number of longitudinal grooves 45 being possible in principle. The longitudinal grooves 45 are not so deep as to reach up to the inner wall 42. However, this is not supposed to be understood in a limiting way. In another exemplary embodiment not shown, the longitudinal grooves 45 can also be designed deeper, so that their groove bottoms coincide with the hollow-cylindrical inner wall 42.

The structured annular elements 43 and 44 constitute combined securing elements. They cooperate with corresponding structural elements disposed on an outer wall of the closure caps 7 and 8, and at the same time, due to the annular structure extending in the circumferential direction, have an axial securing action, and, due to the axially oriented longitudinal grooves 45 simultaneously have an rotation-preventing effect, when the closure cap 7 or 8 is inserted in the coupling sleeve 40. As a securing means for the detachable connection with the concerned closure cap 7 and 8, respectively, only the one structured annular element 43 and 44, respectively, is provided on the coupling sleeve 40 per closure cap 7 or 8.

The coupling sleeve 40 has a non-uniform wall thickness. The outside of the coupling sleeve 40 is structured. It is composed of two partial areas 46 and 47, which run out conically towards the respective axial end face and between which a central cylindrical partial area 48 is disposed. The cylindrical partial area is provided with an inscription 49 engraved into the surface. Other structured configurations of the outside of the coupling sleeve, such as, for example, an undulating surface, are also possible. Again, a non-uniform wall thickness may result in this case. The variation of the wall thickness is in the axial direction. Differences in wall thickness of 0.5 mm and more are readily possible.

1. Cosmetics unit with a central longitudinal axis (21) and comprising two partial units (2, 3) with a storage container (5, 6) each for receiving a cosmetic substance, and with a closure cap (7, 8) each, by means of which the respective storage container (5, 6) can be closed, wherein the two partial units (2, 3) can be detachably connected with each other by means of a coupling sleeve (4; 40), at whose two axial end faces one of the two closure caps (7, 8), respectively, can be inserted,
characterized in that
the coupling sleeve (4; 40) consists of a metal, at least the closure caps (7, 8) consist of a plastic, and the coupling sleeve (4; 40) comprises at an inner wall (42), for each insertable closure cap (7, 8), at least one inwardly protruding combined securing element, which is configured as an annular element (36, 37; 43, 44) which peripherally extends in the circumferential direction and is structured by means of longitudinal elements (31; 45) oriented parallel to the central longitudinal axis (21), so that a detachable connection of the coupling sleeve (4; 40) with the respective closure cap (7, 8) has a rotation-preventing strength due to the longitudinal elements (31; 45), and an axial strength due to the annular element (36, 37, 43, 44).

2. Cosmetics unit according to claim 1, characterized in that a wall thickness (d₁) of the coupling sleeve (4) lies in a range of between 0.05 mm and 1 mm, preferably between 0.05 mm and 0.55 mm.

3. Cosmetics unit according to claim 1, characterized in that the coupling sleeve (4; 40) consists of aluminum.

4. Cosmetics unit according to claim 1, characterized in that the closure cap (7, 8) is provided on an outer circumferential surface with longitudinal webs which are disposed uniformly distributed in the circumferential direction and protrude radially outwardly, with, in particular, between four and 48, preferably between 4 and 16, longitudinal webs being provided.

5. Cosmetics unit according to claim 1, characterized in that the coupling sleeve (4) is provided on its outer circumferential surface with two annular depressions (38, 39), which also become apparent on the inner wall of the coupling sleeve (4) as inwardly directed annular projections (36, 37) and there form the annular elements.

6. Cosmetics unit according to claim 1, characterized in that the coupling sleeve (4) is provided on an inner wall with axially extending and inwardly protruding rotation-preventing projections (31).

7. Cosmetics unit according to claim 6, characterized in that the rotation-preventing projections (31) extend axially across the annular elements (36, 37) of the combined securing elements and form, in the area of the annular elements (36, 37), their longitudinal elements provided for structuring.

8. Cosmetics unit according to claim 6, characterized in that rotation-preventing projections (31) run out at a distance from an axial edge (34) of the coupling sleeve (4).

9. Cosmetics unit according to claim 6, characterized in that rotation-preventing projections (31) extend just up to an axial edge (35) of the coupling sleeve (4).

10. Cosmetics unit according to claim 6, characterized in that the coupling sleeve (4) is provided with four to 48 of the rotation-preventing projections (31).

11. Cosmetics unit according to claim 1, characterized in that the coupling sleeve (4) has an inner space which, apart from the combined securing elements (36, 37), conically tapers from an axial edge (35) towards the other axial edge (34), with the inside diameters of the inner space on the two axial edges (34, 35) differing from each other by a diameter difference of 0.2 mm to 0.5 mm, in particular of 0.25 mm.

12. Cosmetics unit according to claim 1, characterized in that the coupling sleeve (40) has a structured outer surface accompanied by a non-uniform wall thickness.

13. Cosmetics unit according to claim 1, characterized in that the coupling sleeve (40) is provided on an outer wall with a decoration or inscription (49) applied, in particular scratched or engraved, into an outer surface.

14. Cosmetics unit according to claim 1, characterized in that the inner wall (42) of the coupling sleeve (40), apart from the combined securing elements (43, 44), has an uncontoured inner wall surface.
